(19) United States
(12) Patent Application Publication
(10) Pub. No.: US 2013/0180033 A1
(43) Pub. Date: Jul. 18, 2013

(54) HEADSET FOR HELMET AND HELMET COMPRISING HEADSET

(71) Applicants: Seiji Uemoto, Ikeda-shi (JP); Akiko Nakatani, Osaka-shi (JP)

(72) Inventors: Seiji Uemoto, Ikeda-shi (JP); Akiko Nakatani, Osaka-shi (JP)

(73) Assignees: GOLDENDANCE CO., LTD., Osaka (JP); WEST NIPPON EXPRESSWAY MAINTENANCE KANSAI CO., LTD, Osaka (JP)

(21) Appl. No.: 13/813,223

(22) PCT Filed: Sep. 26, 2011
(86) PCT No.: PCT/JP2011/071809

§ 371 Date: Mar. 18, 2013

(30) Foreign Application Priority Data
Sep. 24, 2010 (JP) 2010-213690

(51) Int. Cl. H04R 1/02

(52) U.S. Cl. CPC H04R 1/02
USPC 2/410; 381/151

(57) ABSTRACT

A headset for a helmet transmits audio signals using bone conduction, and transmits audio signals even when not using bone conduction. A headset for a helmet for transmitting audio signals to a user wearing a helmet includes: a bone conduction oscillator which receives the audio signals and emits audio oscillations; an arm part which has the bone conduction oscillator on the leading end side thereof; and an attachment part which attaches the base end side of the arm part on the outer side of the crown of the helmet in a rotatable manner. The bone conduction oscillator is brought into contact with either the head portion of the user or the outer side of the crown, depending on the angle of rotation a of the arm part. The audio signals are thus transmitted to the user when bone conduction is not used by using sounds emitted by the crown.

### TECHNICAL FIELD

The present invention relates to a headset for a helmet which transmits audio signals using bone conduction and a helmet comprising this headset.

### BACKGROUND ART

A bone conduction oscillator is conventionally known (see, for example, Patent Document 1). The bone conduction oscillator is also called a bone conduction speaker and produces audio oscillation by being held in contact with the head portion of a user and receiving audio signals. That audio oscillation is transmitted from the skull to the inner ear by bone conduction bypassing the eardrum and recognized by the user.

There is also known a helmet with a bone conduction oscillator provided on the inner surface of a crown (see, for example, Patent Document 2). Such a helmet cannot be said to be preferable for safety since an impact applied to the crown may be applied to the head portion of a user via the bone conduction oscillator.

There is further known a bone conduction headset in which a bone conduction oscillator is supported on a helmet via an arm part without being provided on the inner surface of a crown (see, for example, Patent Document 3). In this bone conduction headset, the bone conduction oscillator is retracted to a non-interfering position distant from the head portion of a user wearing the helmet for a relief from pain caused by the bone conduction oscillator kept in contact with the head portion of the user. However, since audio signals are not transmitted to the user when the bone conduction oscillator is retracted, such a bone conduction headset is not suitable for an application of transmitting audio signals, which should be constantly transmittable, such as a warning.

### PRIOR ART DOCUMENT

### Patent Document

[Patent Document 1] Japanese Unexamined Patent Publication No. 2007-74693

[Patent Document 2] Japanese Unexamined Patent Publication No. 2008-176457

[Patent Document 3] Japanese Unexamined Patent Publication No. 2004-32340

### OUTLINE OF THE INVENTION

### Problem to be Solved by the Invention

The present invention was developed to solve the above problem and aims to enable an audio signal to be transmitted even when bone conduction is not used in a headset for a helmet which transmits an audio signal using bone conduction.

### Means for Solving the Problem

The present invention is directed to a headset for a helmet which transmits an audio signal to a user wearing a helmet, comprising a bone conduction oscillator for generating audio oscillation upon receiving an audio signal; an arm part with the bone conduction oscillator provided on its tip side; and an attachment part for rotatably mounting a base end side of the arm part to an outer side of a crown of the helmet; wherein the bone conduction oscillator is brought into contact with either the head portion of the user or the outer side of the crown according to an angle of rotation of the arm part.

In this headset for a helmet, preferably, the attachment part includes a supporting portion for rotatably supporting the base end side of the arm part and a fixing portion to be fixed to the crown; and the supporting portion is detachably attached to the fixing portion.

The present invention is also directed to a helmet comprising this headset for a helmet.

### Effect of the Invention

According to the headset for a helmet and the helmet including this headset of the present invention, audio signals are transmitted to the user using bone conduction when the bone conduction oscillator is in contact with the head portion of the user, and audio signals are transmitted to the user using a sound generated by the crown when the bone conduction oscillator is in contact with the outer side of the crown. Therefore, audio signals are transmitted also when the bone conduction is not used.

### BRIEF DESCRIPTION OF DRAWINGS

FIG. 1 is a perspective view of a headset for a helmet according to one embodiment of the present invention,

FIG. 2 is a perspective view of the headset in which an angle of rotation of an arm part is changed,

FIG. 3 is a perspective view of the headset in which the angle of rotation of the arm part is further changed,

FIG. 4 is a perspective view of the headset before a supporting portion is inserted into a fixing portion,

FIG. 5 is a side view of the arm part and the supporting portion of the headset,

FIG. 6 is a front view of the arm part and the supporting portion of the headset,

FIG. 7 is a sectional view of the fixing portion of the headset, and

FIG. 8 is a sectional view of a modification of the fixing portion of the headset.

### EMBODIMENTS FOR CARRYING OUT THE INVENTION

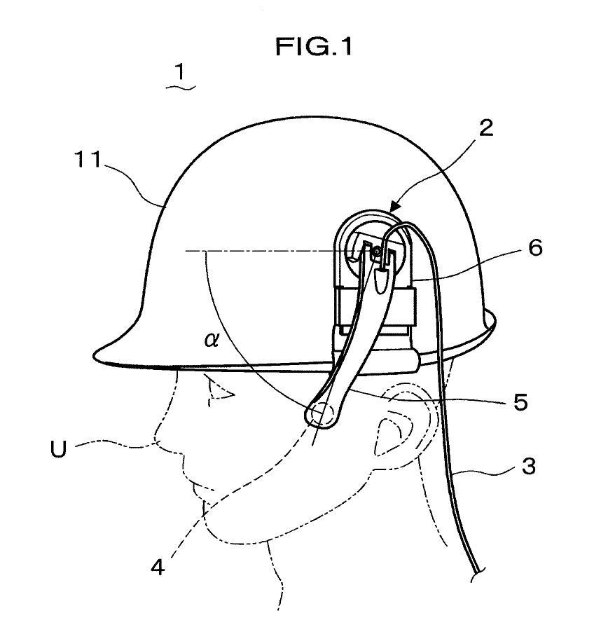

A headset for a helmet (hereinafter, referred to as a headset) according to one embodiment of the present invention is described with reference to FIGS. 1 to 7. As shown in FIGS. 1 to 3, a helmet 1 includes a headset 2. The headset 2 is for transmitting an audio signal to a user U wearing the helmet 1 and includes a cord 3, a bone conduction oscillator 4, an arm part 5 and an attachment part 6. The audio signal is input to the bone conduction oscillator 4 from the outside via the cord 3. The bone conduction oscillator 4 generates audio oscillation upon receiving the audio signal. The arm part 5 includes the bone conduction oscillator 4 provided on its tip side. The attachment part 6 rotatably mounts a base end side of the arm part 5 to an outer side of a crown 11 of the helmet 1. The bone conduction oscillator 4 is brought into contact with the head portion of the user U or the outer side of the crown 11 according to an angle of rotation α of the arm part 5.

The helmet 1 is, for example, a work helmet and worn to protect the head portion of the working user U, i.e. a worker. Note that a chin strap of the helmet 1 is not shown.

The audio signal is a signal including audible sound information for transmitting information, e.g. an operation instruction, an evacuation instruction, a warning or the like to the user U, which is wirelessly transmitted to the user U and received by a transceiver (not shown) carried by the user U. The headset 2 is electrically connected to the transceiver by the cord 3 and the audio signal is input from the transceiver to the bone conduction oscillator 4.

The bone conduction oscillator 4 includes a diaphragm, a voice coil for vibrating the diaphragm by a magnetic force, and the like. An audio signal is input to the voice coil and the diaphragm generates audio oscillation. The audio oscillation is a vibration capable of being transmitted by bone conduction in an audible spectrum. The bone conduction oscillator 4 may generate audio oscillation using a piezoelectric element.

The arm part 5 is an arched arm-like member and the base end side is mounted to an outer lateral part of the crown 11 by the attachment part 6. The arm part 5 is connected to the attachment part 6 by a spring hinge structure and brings the bone conduction oscillator 4 into contact with the head portion of the user U or the outer side of the crown 11 by a spring force. A curved leaf spring may be provided in the aim part 5 and the bone conduction oscillator 4 may be brought into contact with the head portion of the user U or the outer side of the crown 11 by the elasticity of that leaf spring.

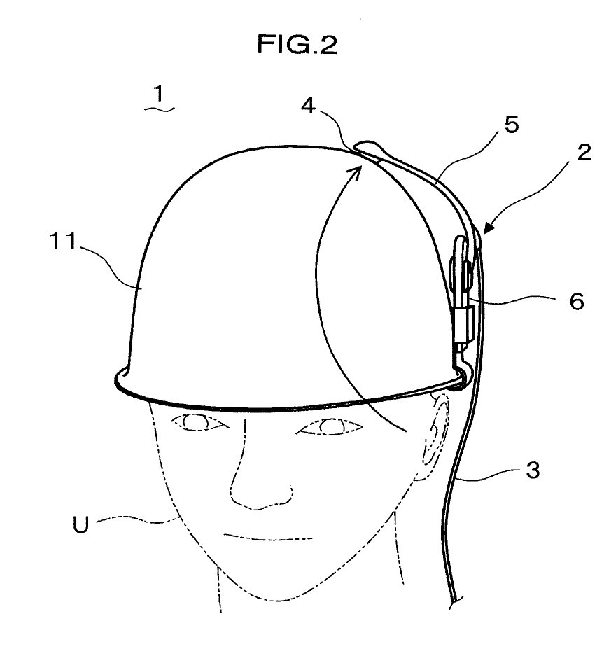

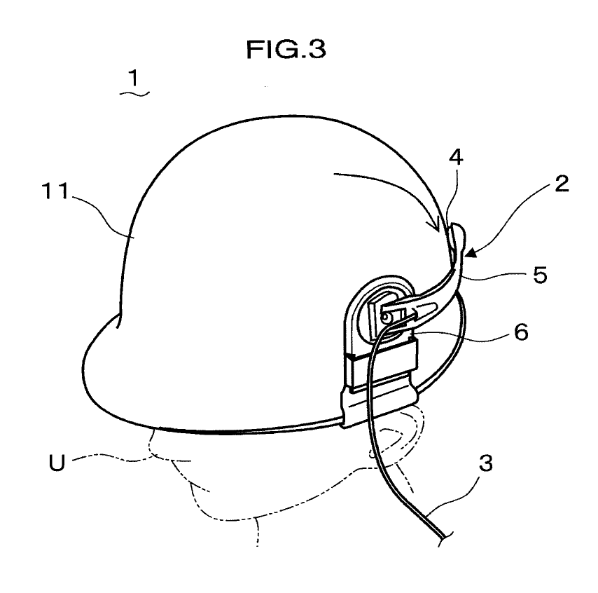

The angle of rotation α of the arm part 5 is an angle of inclination with respect to a front-back direction of the attachment part 6 or the crown 11 and changes according to the rotation of the arm part 5. The position of the bone conduction oscillator 4 changes according to the angle of rotation α of the arm part 5. As shown in FIG. 1, the bone conduction oscillator 4 is brought into contact with the head portion of the user U when the tip side of the arm part 5 is facing substantially downward. At this time, the bone conduction oscillator 4 is preferably brought into contact with the cheek bone near the temple. As shown in FIG. 2, the bone conduction oscillator 4 is brought into contact with the vicinity of an outer top part of the crown 11 when the tip side of the arm part 5 is rotated upwardly. As shown in FIG. 3, the bone conduction oscillator 4 is brought into contact with an outer rear part of the crown 11 when the tip side of the arm part 5 is rotated backwardly. When the tip side of the arm part 5 is rotated downwardly, the bone conduction oscillator 4 is brought into contact with the head portion of the user U again as shown in FIG. 1. In this way, the user U can switch a contact position of the bone conduction oscillator 4 to the head portion of the user U or the outer side of the crown 11 by rotating the arm part 5.

In the headset 2 configured as described above, the bone conduction oscillator 4 generates audio oscillation upon receiving an audio signal. When the bone conduction oscillator 4 is in contact with the head portion of the user U (see FIG. 1), the audio oscillation generated by the bone conduction oscillator 4 is transmitted to the inner ear as a bone conduction sound transmitting through the skull of the user U bypassing the eardrum and recognized by the user U. Thus, the audio signal is transmitted to the user U using bone conduction.

Further, when the bone conduction oscillator 4 is in contact with the outer side of the crown 11 (see FIGS. 2 and 3), the audio oscillation generated by the bone conduction oscillator 4 vibrates the crown 11. The crown 11 generates a sound by that oscillation. The sound generated by the crown 11 reaches the eardrum of the user U as an air conduction sound transmitting in the air, is transmitted from the eardrum to the inner ear and recognized by the user U. Thus, the audio signal is transmitted to the user U using the sound generated by the crown 11.

As just described, according to the headset 2 of this embodiment, an audio signal is transmitted to the user U using bone conduction when the bone conduction oscillator 4 is in contact with the head portion of the user U, and an audio signal is transmitted to the user U using a sound generated by the crown 11 when the bone conduction oscillator 4 is in contact with the outer side of the crown 11. Therefore, an audio signal is transmitted also when the bone conduction is not used.

A use example of this headset 2 is described. For example, the user U wears the helmet 1 as a worker and brings the bone conduction oscillator 4 of the headset 2 into contact with the head portion of the user U during an operation. The headset 2 transmits an audio signal such as an operation instruction to the user U using bone conduction. Since the headset 2 closes neither of the ears of the user U, the user U can recognize ambient sounds and directions of sound sources thereof and operation safety is improved. Further, since an audio signal is transmitted using bone conduction, the content of the audio signal is not heard by any person other than the user U and secrecy ability is ensured.

The user U can remove the feeling of pressure caused by the bone conduction oscillator 4 by bringing the bone conduction oscillator 4 into contact with the outer side of the crown 11 while wearing the helmet 1, for example, during a break. At this time, since the headset 2 transmits an audio signal such as a warning to the user U using a sound generated by the crown 11, safety during a break and the like is improved.

Further, in the helmet 1, the bone conduction oscillator 4 is not located between the inner side of the crown 11 and the head portion of the user U regardless of the angle of rotation α of the arm part 5. Thus, even if an impact is applied to the crown 11 from the outside, such an impact is not applied to the head portion of the user U via the bone conduction oscillator 4, wherefore the helmet 1 has high safety against impact.

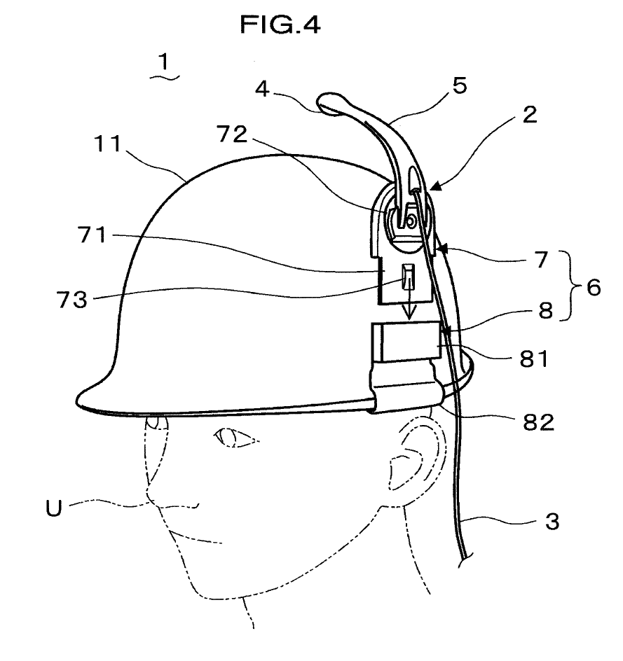

Next, the attachment part 6 of the headset 2 is further described in detail. In this embodiment, as shown in FIG. 4, the attachment part 6 includes a supporting portion 7 for rotatably supporting the base end side of the arm part 5 and a fixing portion 8 to be fixed to the crown 11. The supporting portion 7 is detachably attached to the fixing portion 8.

The supporting portion 7 includes a flat plate portion 71 in the form of a flat plate and a rotary portion 72 rotatably provided on the flat plate portion 71. The arm part 5 is connected to the rotary portion 72. The fixing portion 8 is molded of synthetic resin and includes a holder 81 in the form of a rectangular flat tube and a clamping portion 82 for clamping an edge part of the crown 11. The clamping portion 82 fixes the fixing portion 8 to the crown 11 by clamping the edge part of the crown 11 by an elastic force. At this time, the holder 81 is located at the outer side of the crown 11. A lower part of the flat plate portion 71 is inserted and fitted into the holder 81. A projection 73 is formed on a surface of the lower part of the flat plate portion 71. When the flat plate portion 71 is fitted into the holder 81, the projection 73 comes into contact with an inner surface of the holder 81 to increase connection resistance between the flat plate portion 71 and the holder 81 and prevent detachment of the supporting portion 7 from the fixing portion 8.

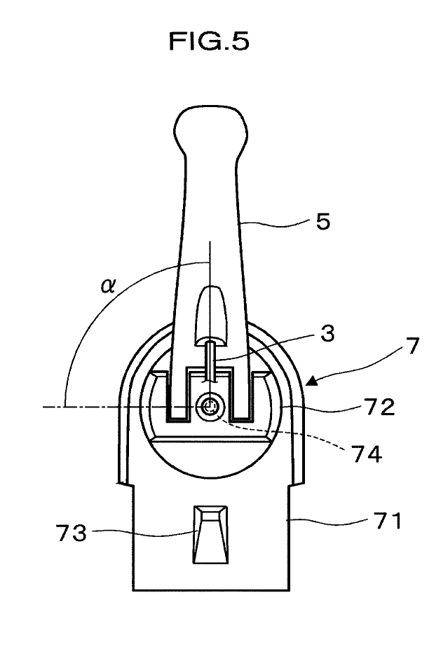

As shown in FIG. 5, a supporting shaft 74 is provided on the flat plate portion 71 of the supporting portion 7. The rotary portion 72 rotates 360 degrees about the supporting shaft 74 in response to the operation of the user U. A direction of the supporting shaft 74 is a lateral direction of the user U in a state where the user U is wearing the helmet 1. The arm part 5 rotates together with the rotary portion 72 and the angle of rotation α thereof is held by rotational resistance of the rotary portion 72 and a frictional force between the bone conduction oscillator 4 and the head portion of the user U or the crown 11. The rotary portion 72 and the arm part 5 may be configured to be rotatable in an angular range smaller than 360 degrees if a contact position of the bone conduction oscillator 4 can be switched to the head portion of the user U or the outer side of the crown 11.

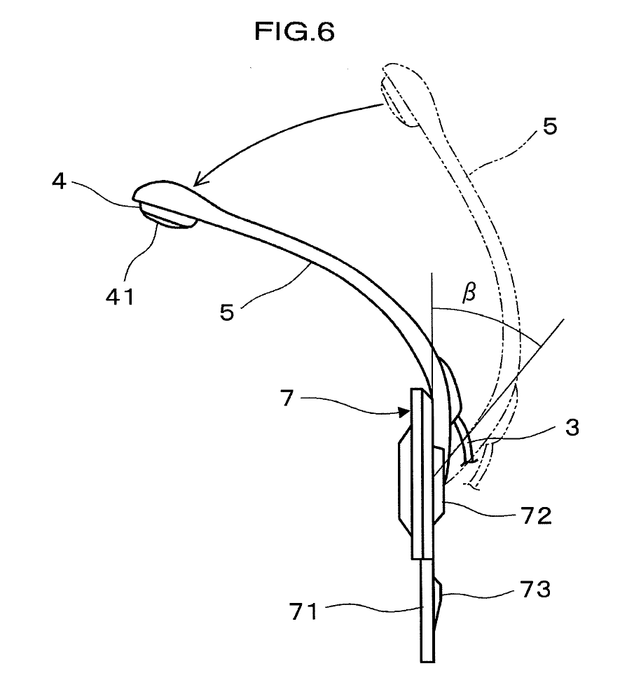

As shown in FIG. 6, the base end side of the arm part 5 is rotatably connected to the rotary portion 72 by the spring hinge structure. An axial direction of the rotation thereof is a front-back direction of the user U in the state where the user U is wearing the helmet 1. A rotational angle range β is, for example, about 40 degrees. The arm part 5 is biased in a direction of an arrow so that the bone conduction oscillator 4 comes into contact with the head portion of the user U or the outer side of the crown 11. The bone conduction oscillator 4 includes a flexible member 41 made of silicone rubber or the like on a part to be held in contact with the user U. The flexible member 41 improves adhesion when the bone conduction oscillator 4 comes into contact with the head portion of the user U and reduces the feeling of pressure received by the user U.

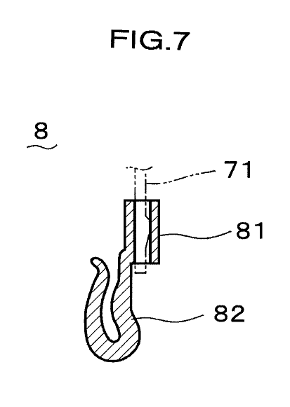

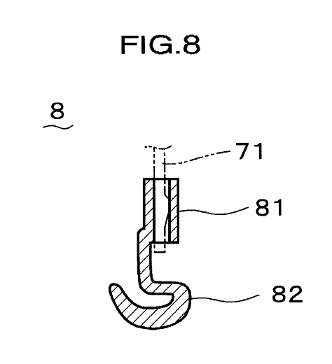

As shown in FIGS. 7 and 8, the clamping portion 82 has a cross-sectional shape in conformity with the shape of the edge part of the crown 11. The fixing portion 8 shown in FIG. 7 is for a helmet having no groove on the edge part of the crown 11, and a fixing portion 8 shown in FIG. 8 is for a helmet with a groove formed on the edge part of the crown 11.

In the headset 2 including such an attachment part 6, normally, the fixing portion 8 is constantly fixed to the helmet 1 and a principal part, which is a part other than the fixing portion 8, is attached and detached as needed. Accordingly, the principal part of the headset 2 can be easily attached to and detached from the helmet 1. Further, the headset 2 can be mounted to a helmet 1 having a differently shaped edge part of a crown 11 only by replacing the fixing portion 8.

Note that the present invention is not limited to the configuration of the above embodiment and various modifications can be made within a range of not changing the gist of the invention. For example, the helmet 1 is not limited to the work helmet and may be, for example, a motorcycle helmet or military helmet. Further, an audio signal may include music and an input source of the audio signal is not limited to the transceiver and may be a portable audio device or the like.

Further, the arm part 5 may be telescopic. This enables the adjustment of a position in the moving radius direction when the bone conduction oscillator 4 is brought into contact with the head portion of the user U.

Further, the headset 2 may be so configured that the magnitude of audio oscillation generated by the bone conduction oscillator 4 is variable according to the range of the angle of rotation α of the arm part 5. This enables the headset 2 to set sound volume according to the contact position of the bone conduction oscillator 4.

Further, the attachment part 6 may be such that the supporting portion 7 and the fixing portion 8 are integrally formed and the clamping portion 82 is formed to be continuous with the flat plate portion 71. Further, the fixing portion 8 may be omitted from the attachment part 6 and the supporting portion 7 may be bonded to the outer side of the crown 11. Further, a receiver for receiving an audio signal and inputting it to the bone conduction oscillator 4 may be provided on the attachment part 6 and the cord 3 may be omitted.

### LIST OF REFERENCE SIGNS

1 helmet
11 crown
2 headset for a helmet
4 bone conduction oscillator
5 arm part
6 attachment part
7 supporting portion
8 fixing portion
α angle of rotation

1. A headset for a helmet which transmits an audio signal to a user wearing a helmet, comprising:
a bone conduction oscillator for generating audio oscillation upon receiving an audio signal;
an arm part with the bone conduction oscillator provided on its tip side; and
an attachment part for rotatably mounting a base end side of the arm part to an outer side of a crown of the helmet;
wherein switching is performed between a state where the bone conduction oscillator is in contact with the head portion of the user and a state where the bone conduction oscillator is in contact with the outer side of the crown according to an angle of rotation of the arm part.

2. The headset for a helmet according to claim 1, wherein:
the attachment part includes a supporting portion for rotatably supporting the base end side of the arm part and a fixing portion to be fixed to the crown; and
the supporting portion is detachably attached to the fixing portion.

3. A helmet, comprising the headset for a helmet according to claim 1.

4. A helmet, comprising the headset for a helmet according to claim 2.
